(19) United States
(12) Patent Application Publication
(10) Pub. No.: US 2010/0315247 A1
(43) Pub. Date: Dec. 16, 2010

(54) Multi-function LED lighting device

(76) Inventor: Yong-Teng Tseng, Taipei (TW)

Correspondence Address: SAM CHEN, 7F-1, 293, ROOSEVELT ROAD, SEC 3, TAIPEI, TW

(21) Appl. No.: 12/481,629

(22) Filed: Jun. 10, 2009

(51) Int. Cl. G08B 17/10; H05B 37/02; G08C 19/00; H04N 7/18

(52) U.S. Cl. 340/628; 315/153; 340/825.69; 348/143; 348/E07.085

(57) ABSTRACT

A multi-function LED lighting device includes a light-sensitive switch on a housing; light sources including a light sensor and first LEDs wherein one light source further has second LEDs; and a controller including a CDS member, a detector, and an on/off switch. The detector may receive a signal from each light sensor and send same to the on/off switch for activation. Each light sensor may sense a predetermined area of a room and provide a signal to the detector in response to a detection of a presence of a person in the predetermined area, the detector is enabled by the signal to activate one of sections of the on/off switch electrically connected to the first LEDs of one light source. The light-sensitive switch may turn on and activate the CDS member in response to a dark environment, and the activated CDS member may enable the second LEDs.

### BACKGROUND OF THE INVENTION

1. Field of Invention

The invention relates to LED (light-emitting diode) lighting devices and more particularly to a multi-function LED lighting device.

2. Description of Related Art

LEDs are renowned for their long life and their ability to resist shock. Also, an LED consumes much less electrical power than fluorescent lamps (i.e., energy saving). Therefore, LED lighting devices are gaining popularity worldwide.

However, LED lighting devices have drawbacks including strong directivity (being a point light source) and glaring quality. Also, a single LED member produces a small amount of light. Thus, it is typical for an LED lighting device having a plurality of LED members so as to add illuminating effects.

One type of conventional LED lighting device has a flat housing. It has sufficient brightness. However, its illumination area is limited. Another type of conventional LED lighting device has an arcuate housing. It has a large illumination area. However, it does not have sufficient brightness.

Taiwanese Publication Application No. 515,107 discloses an energy saving LED lamp. It is characterized in that a predetermined number of LED elements thereof are enabled when a light sensor senses the approach of a person from one direction of a door (i.e., the lamp is brightened); and the predetermined number of LED elements are disabled when the light sensor senses the leaving of a person from the other opposite direction of the door (i.e., the lamp dims).

Thus, continuing improvements in the exploitation of LED lighting device are constantly being sought.

### SUMMARY OF THE INVENTION

It is therefore one object of the invention to provide a multi-function LED lighting device.

The above and other objects, features and advantages of the invention will become apparent from the following detailed description taken with the accompanying drawings.

### BRIEF DESCRIPTION OF THE DRAWINGS

FIG. 1 is a perspective view of a preferred embodiment of LED lighting device according to the invention;

FIG. 2 is an exploded view of the LED lighting device;

FIG. 3 is an end view of the LED lighting device;

FIG. 4 is an enlarged plan view of the fixed light source of FIG. 3; and

FIG. 5 is a circuit block diagram of the controller of the LED lighting device.

### DETAILED DESCRIPTION OF THE INVENTION

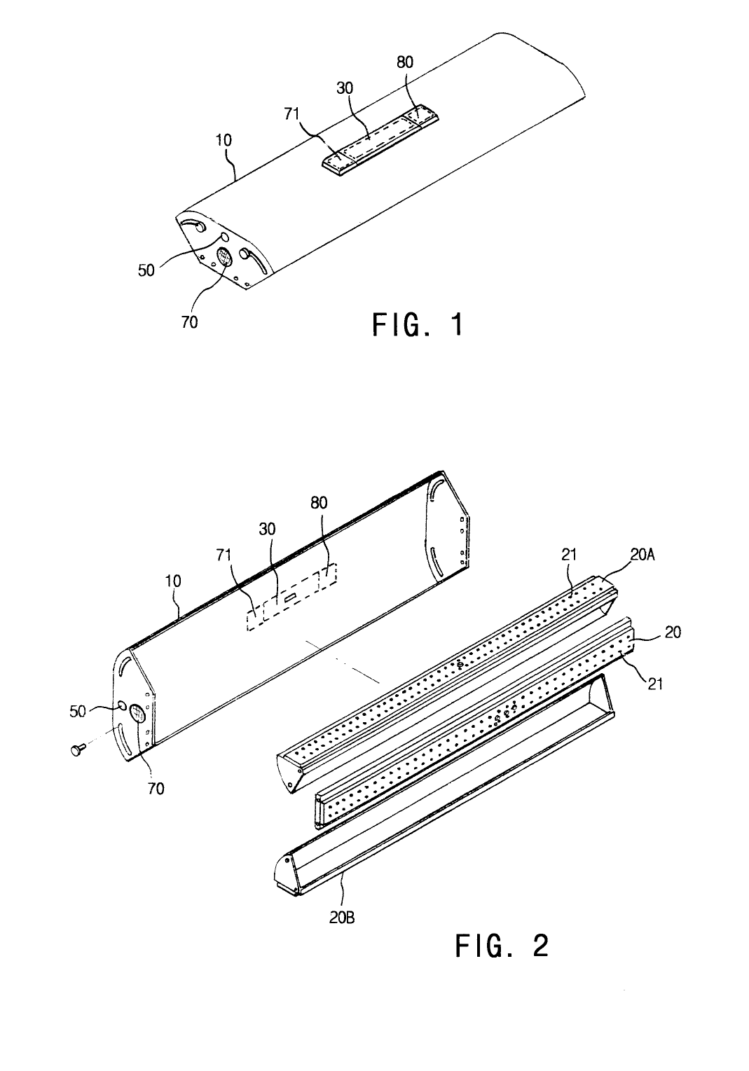

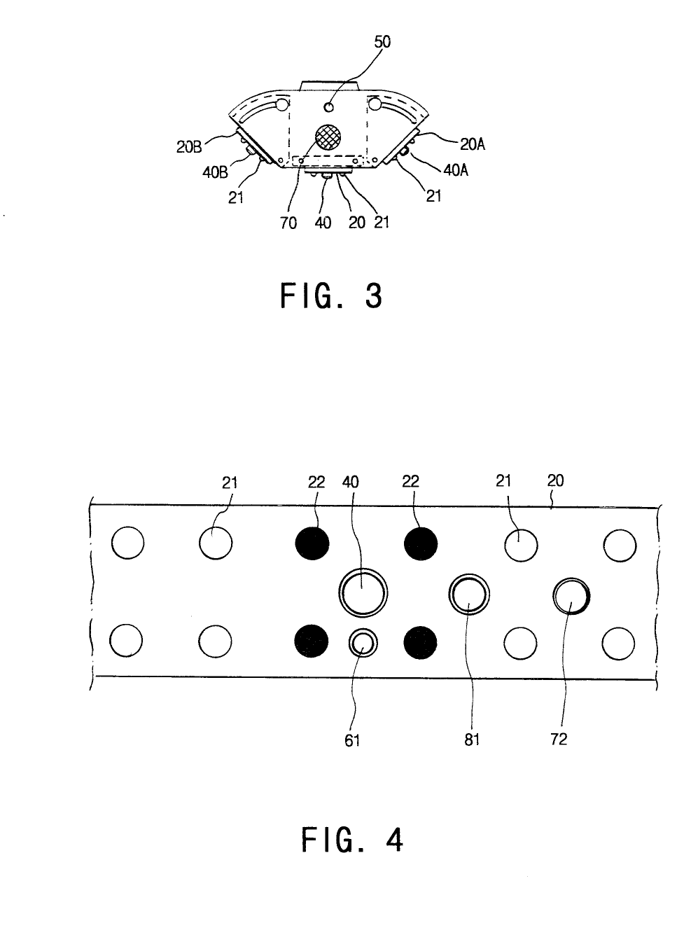

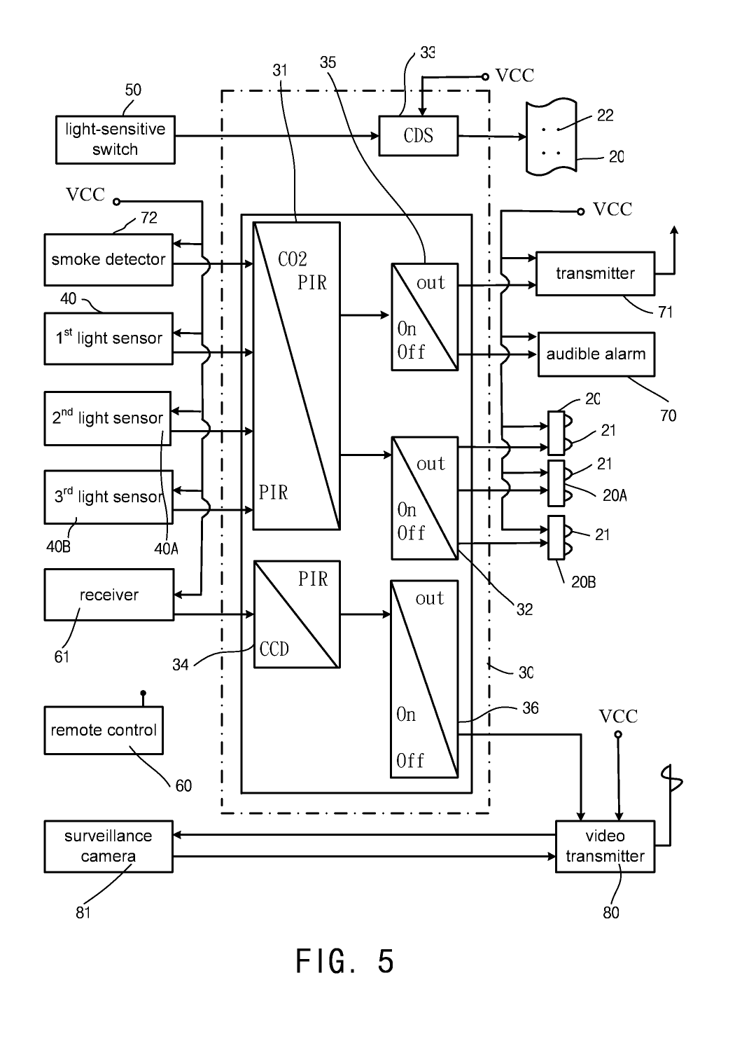

Referring to FIGS. 1 to 5, an LED lighting device in accordance with a preferred embodiment of the invention comprises the following components as discussed in detail below.

A glass housing 10 is elongated and has a substantially truncated conic longitudinal section. There are provided two pivotal light sources 20A, 20B on both inclined sides of the housing 10 and a fixed light source 20 on a bottom thereof. A plurality of first LED members 21 arranged in rows and columns are provided on each of the light sources 20, 20A, 20B. Also, A first light sensor 40 is provided on the light source 20, a second light sensor 40A is provided on the light source 20A, and a third light sensor 40B is provided on the light source 20B respectively. Each of the light sensors 40, 40A, 40B is powered by a voltage source (VCC). Each of the light sensors 40, 40A, 40B is an IR (infrared) sensor in this embodiment. A controller 30 is provided on an arcuate top of the housing 10. Moreover, a plurality of (e.g., four) second LED members 22 arranged as a square are provided around the first light sensor 40 and are served as a nightlight.

As shown in FIG. 5, the controller 30 comprises a detector (e.g., Passive infrared (PIR) sensor and carbon dioxide (CO2) sensor combination) 31 and an on/off switch 32. The detector 31 is adapted to receive a signal from each of the light sensors 40, 40A, 40B. The detector 31 is adapted to send the signal to the on/off switch 32 for activation. The on/off switch 32 is electrically connected to the first LED members 21 of the light sources 20, 20A, 20B.

The first light sensor 40 is adapted to sense a specific area (e.g., door) of a room and can provide a signal to the detector 31 in response to the approach of a person from one direction of the door. And in turn, the detector 31 is enabled to activate a first section of the on/off switch 32 which in turn enables the first LED members 21 of the fixed light source 20. (i.e., the fixed light source 20 is brightened). Likewise, the second light sensor 40A is adapted to sense another specific area (e.g., an intermediate location between the door and a living room of the room) and can provide a signal to the detector 31 in response to the approach of the person to the intermediate location between the door and the living room. And in turn, the detector 31 is enabled to activate a second section of the on/off switch 32 which in turn enables the first LED members 21 of one pivotal light source 20A (i.e., one pivotal light source 20A is brightened). Still likewise, the third light sensor 40B is adapted to sense yet another specific area (e.g., a living room) of the room and can provide a signal to the detector 31 in response to the approach of the person to the living room. And in turn, the detector 31 is enabled to activate a third section of the on/off switch 32 which in turn enables the first LED members 21 of the other pivotal light source 20B (i.e., the other pivotal light source 20B is brightened). This arrangement has the benefit of saving energy.

A light-sensitive switch 50 is provided on one end plate of the housing 10 and is adapted to turn on and generate a signal in response to a dark environment. The controller 30 further comprises a Correlated Double Sampling (CDS) member 33 powered by a voltage source (VCC). The CDS member 33 is adapted to receive the signal from the light-sensitive switch 50, process same, and enables the second LED members 22 of the nightlight as a response. In brief, the nightlight may turn on automatically when the room is dark.

Each of the light sources 20, 20A, 20B can be enabled by a remote control. For example, a user may use a remote control (e.g., an IR remote control) 60 to send an IR signal to a receiver 61 on the fixed light source 20. The receiver 61 may send the received signal to a sensor assembly (e.g., charge-coupled device (CCD) and PIR sensor combination) 34 on the controller 30. The sensor assembly 34 may send a signal to the detector 31 for activation after processing the signal sent from the receiver 61. And in turn, one of the first, second, and third sections of the on/off switch 32 is on. As a result, the first LED members 21 of the fixed light source 20 are enabled (i.e., the fixed light source 20 is brightened). The activation of either pivotal light source 20A or 20B can be done in a similar way. It is noted that the activation of the sensor assembly 34 will automatically disable the light sensors 40, 40A, 40B in this operating mode.

The controller 30 further comprises an alarm switch 35 adapted to receive an alarm signal from the detector 31 which is activated when sensing the approach of a person (e.g., thief) from one direction of a door. The alarm switch 35 may then activate the on/off switch 32 to turn on all of the light sources 20, 20A, 20B and activate both an audible alarm 70 and a transmitter 71 (provided besides the controller 30) as a response. The activated alarm 70 can make a buzzing sound and the transmitter 71 may send a wireless signal to the owner of the room as warning.

A smoke detector 72 is, for example, provided on the fixed light source 20. The smoke detector 72 may be activated when detecting the presence of carbon monoxide, carbon dioxide, or smoke in the room. The activated smoke detector 72 then sends a signal to the detector 31. And in turn, the alarm switch 35, the alarm 70, and the transmitter 71 are activated to perform actions as described above.

The controller 30 further comprises a video switch 36 which is activated by the sensor assembly 34. A surveillance camera 81 is provided on the fixed light source 20 and is adapted to take images at, for example, the door. The surveillance camera 81 may send the recorded images to a video transmitter 80 (provided besides the controller 30). The video transmitter 80 in turn sends the images to a security monitor located at a guard house. A person may turn on the video switch 36 when leaving the room (i.e., both the surveillance camera 81 and the video transmitter 80 are turned on). Hence, a security employ at the guard house may immediately know what is happening in a room (e.g., the approach of a person at the door) by watching the security monitor. This is an anti-thief arrangement.

While the invention herein disclosed has been described by means of specific embodiments, numerous modifications and variations could be made thereto by those skilled in the art without departing from the scope and spirit of the invention set forth in the claims.

What is claimed is:

1. An LED lighting device comprising:
a housing;
a light-sensitive switch disposed on the housing;
a plurality of light sources each including a light sensor and a plurality of first LED members wherein one of the light sources further has a plurality of second LED members; and
a controller disposed on the housing and including a Correlated Double Sampling (CDS) member, a detector, and an on/off switch wherein the detector may receive a signal from each of the light sensors and send the signal to the on/off switch for activation;
wherein each of the light sensors may sense a predetermined area of a room and provide a signal to the detector in response to a detection of a presence of a person in the predetermined area, the detector is enabled by the signal to activate one of a plurality of sections of the on/off switch electrically connected to the first LED members of one of the light sources; and
wherein the light-sensitive switch may turn on and activate the CDS member in response to brightness of the room less than a predetermined value, and the activated CDS member may enable the second LED members.

2. The LED lighting device of claim 1, wherein each of the light sensors is an infrared (IR) sensor.

3. The LED lighting device of claim 1, wherein the controller further comprises a sensor assembly, the LED lighting device further comprising a receiver disposed on one of the light sources, wherein the receiver may receive a signal from a remote control and send the signal to the sensor assembly, the sensor assembly may activate the detector after processing the signal sent from the receiver, and the activated detector may activate the sections of the on/off switch to activate the first LED members of the light sources.

4. The LED lighting device of claim 3, wherein the sensor assembly is a charge-coupled device (CCD) and Passive infrared (PIR) sensor combination.

5. The LED lighting device of claim 1, further comprising a smoke detector disposed on one of the light sources, an audible alarm disposed on the housing, and a transmitter disposed on the housing, wherein the controller further comprises an alarm switch, and wherein the smoke detector may detect a presence of a toxic gas or smoke and send a warning signal to the detector which in turn activates the alarm switch, and the activated alarm switch activates both the audible alarm and the transmitter.

6. The LED lighting device of claim 1, further comprising a surveillance camera disposed on one of the light sources for monitoring a predetermined area of the room, and a video transmitter disposed on the housing for transmitting images taken by the surveillance camera to a predetermined display device, wherein the controller further comprises a video switch for activating the video transmitter.
